(19) United States
(12) Patent Application Publication
(10) Pub. No.: US 2009/0178072 A1
(43) Pub. Date: Jul. 9, 2009

(54) Content blocking system and method for a consumer electronic product

(75) Inventor: Josh P. Hardin, Lebanon, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS L.L.C., Wayne, NJ (US)

(21) Appl. No.: 12/285,488

(22) Filed: Oct. 7, 2008

Related U.S. Application Data
(60) Provisional application No. 61/006,311, filed on Jan. 7, 2008.

(51) Int. Cl. H04N 7/16

(52) U.S. Cl. 725/28

(57) ABSTRACT

An example program blocking system and method involve enabling and disabling program blocking on a group of channels responsive to stored blocking settings. When program blocking on the group of channels is enabled in response to the stored blocking settings, the blocking of programs on one or more channels in the group may be selectively disabled in response to a blocking disable command for disabling blocking on those channels.

### CROSS REFERENCE TO RELATED APPLICATION

This application claims the benefit of provisional application No. 61/006,311, filed Jan. 7, 2008, the contents of which are incorporated herein in their entirety.

### BACKGROUND AND SUMMARY

The subject application generally relates to controlling blocking and unblocking output of one or both of audio and video content from a consumer electronic product such as a television. More specifically, this application describes by way of example, and without limitation, systems and methods for selectively blocking and unblocking output of one or both of audio and video content from a television.

Various systems and methods are known for blocking the viewing of television programs. Such systems and methods are often used to prevent children from viewing televisions programs that are deemed by their parents to be unsuitable.

The so-called V-chip is an example of a system that can be used to block the display of a program based on its rating. Since January 2001, all televisions sets having screens 13 inches or larger have been required to include V-chip technology. Generally speaking, parents can use the V-chip technology to set limits on programs that can be viewed by their children. For example, a parent could decide that all programs having a rating higher than “TV-PG” in the TV parental Guidelines rating scheme will be blocked. By appropriately configuring the “V-chip” through the television's user interface, the television will compare the rating of a program on a tuned-to channel with a rating level set by the parent. If the rating of the program exceeds the acceptable rating level, viewing of the program (i.e., output of both sound and video) is blocked.

Sometimes, a parent may wish to permit a child to view a program that exceeds the rating level set using the V-chip. This application describes example systems and methods by which a program or channel can be temporarily unblocked for viewing. By way of illustration and without limitation, an example program blocking system and method involve enabling and disabling program blocking responsive to stored blocking settings. Programs are selectively blocked when program blocking is enabled. The blocking of programs on a particular channel may be selectively inhibited in response to a blocking disable command for disabling blocking on that channel.

### BRIEF DESCRIPTION OF THE DRAWINGS

FIG. 1 is a highly generalized block diagram of an example television 100 in which the example systems and methods described herein may be implemented.

FIG. 2 provides a more detailed view of example remote control 150 in FIG. 1.

FIGS. 3A and 3B show example display screens used to set program blocking information.

FIG. 4 shows an example display screen used to temporarily inhibit program blocking.

FIG. 5 shows a non-limiting example process for selectively blocking output of a consumer electronic product.

### DETAILED DESCRIPTION OF EXAMPLE EMBODIMENTS

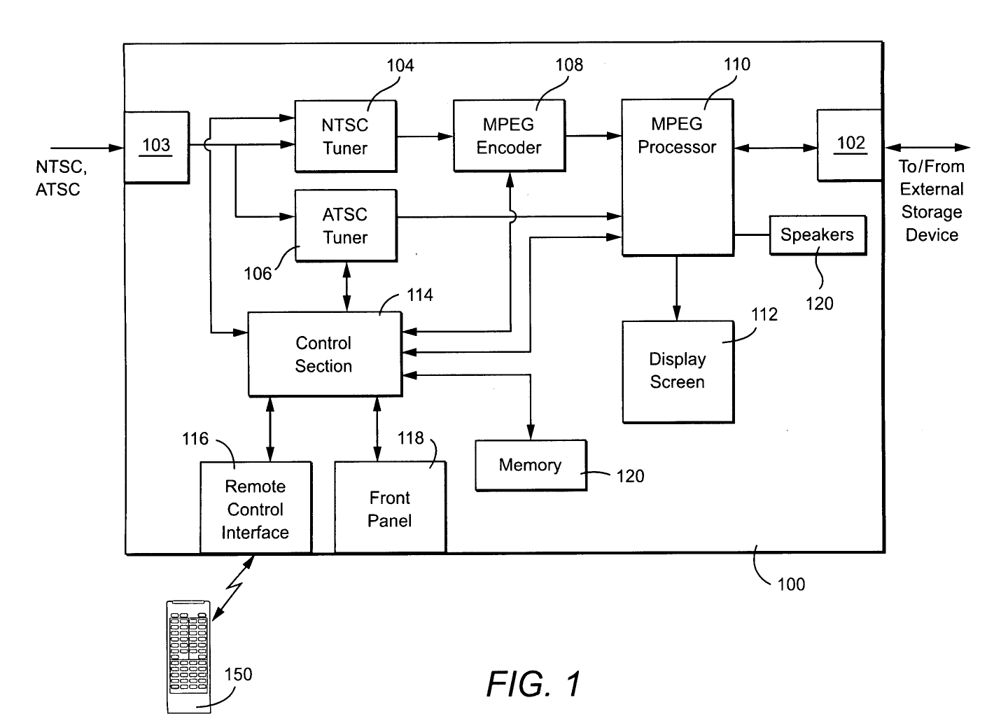

FIG. 1 is a highly generalized block diagram of a television 100 in which the example systems and methods described herein may be implemented. The details of television 100 are provided by way of example only and it will be readily apparent that the systems and methods described herein may be implemented in a wide variety of televisions of different configurations, both analog and digital.

An input 103 of the television receives NTSC and ATSC signals. The NTSC signals are supplied to an NTSC tuner 104 and the ATSC signals are supplied to an ATSC tuner 106. Other inputs (not shown) may also be supplied to the television. For example, the television may receive HDMI signals or the output from a DVD player. The output of NTSC tuner 104 is supplied to an MPEG encoder 108 which MPEG encodes the tuned NTSC signal. The outputs of ATSC tuner 106 and MPEG encoder 108 are supplied to an MPEG AV processor 110. MPEG AV processor 110 processes the MPEG transport stream from the ATSC tuner 106 and/or MPEG encoder 108 and supplies a display signal to display screen 112 and a sound signal to speakers 120. MPEG AV processor 110 also selectively outputs an MPEG transport stream to and receives an MPEG transport stream from an external storage system via interface 102. The external storage system may, for example, include a hard disk drive (HDD) recording device, a DVD recording device, or an HDD/DVD recording device. Generally speaking, MPEG AV processor 110 is a standard processing device used in conventional digital integrated televisions, monitors and set-top box (STB) units that receives MPEG compressed AV data and decompresses and processes the AV data for output via display screen 112 and speakers 120.

A control section 114, including a CPU, for example, controls the overall operations of television 100. In general, control section 114 may include, for example, a microprocessor, a microcontroller, a processor, a controller, an application specific integrated circuit (ASIC), logic circuitry, a state machine and/or combinations thereof. Control section 114 may be supplied with inputs from a user via a remote control interface 116 for a remote control 150 (e.g., an infrared remote control) and front panel keys 118. MPEG AV processor 110 may selectively block output of audio and/or video in accordance with control signals from control section 114.

Memory 120, which may be a combination of volatile and non-volatile semiconductor memory, stores various operating programs and user settings (e.g., rating level(s) set by parents) used by control section 114 to control the operation of television 100. For example, memory 120 may include ROM storing an operating program for execution by the control section 114 to implement the systems and methods described herein. This operating program may provide for control of tuners 104, 106; control of MPEG AV processor 110 to generate displays for display on display screen 212 and sounds for output via speakers 120; processing of inputs supplied by a user via front panel 118 and/or remote control 150; and the like. Memory 120 may also include SDRAM for use by control section 114 during execution of the operating program.

Television 100 may also be provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to the external storage device via interface 102). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

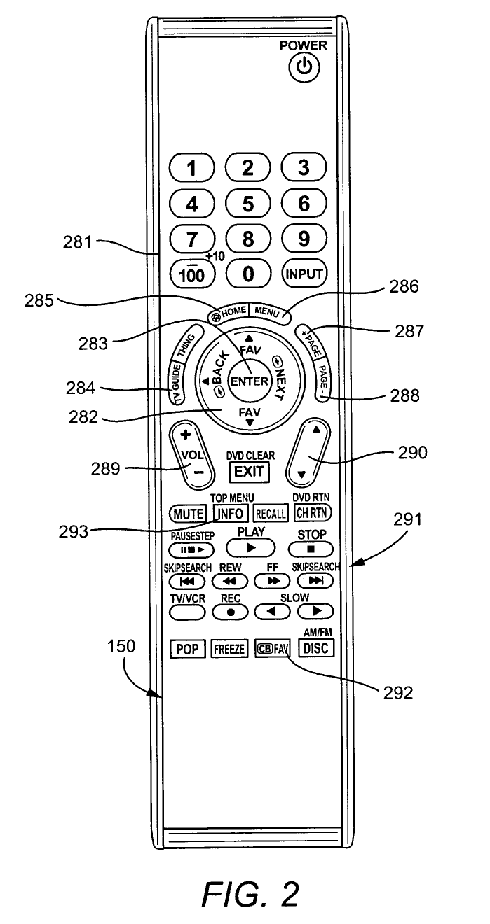

FIG. 2 shows an example layout of keys and buttons for remote control 150. The keys or buttons of remote control 150 may be appropriately labeled to assist the user in selecting a desired function. Alternatively or additionally, television 100 may provide one or more displays that inform the user which key(s) or button(s) should be actuated to input desired commands. Other types of inputs such as voice inputs may also be used to input commands in certain implementations.

Remote control 150 includes a numeric keypad 281 including the numbers 0-9. Keypad 281 also includes a “−/100” key for use in entering channel numbers greater than 100 and a delimiter for separating major and minor channel numbers (e.g., channel 125-3). An “Input” key is provided for use in switching between different inputs to television 100 (e.g., different antennas, different video inputs, different devices connected to the television, etc.). Remote control 150 also includes a navigation switch 282 that provides for up, down, left and right navigation through menus, program guides, and the like. An enter key 283 is also provided. Various keys are provided around part of the periphery of navigation switch 282. A “program guide” key 284 causes a program guide to be displayed. A “home” key 285 causes television 200 to tune to a HOME channel. A “menu” key 286 causes television 200 to display an initial menu screen for accessing various features of television 200. A “Page +” key 287 and a “Page −” key 288 provide for navigation through menus, program guides, etc. A volume up/down key 289 and a channel up/down key 290 permit the user to set the volume level and to select television channels. A DVD/VCR keypad 291 allows the user to control a DVD player and/or a VCR. A “Fav” key 292 accesses a favorite channel feature. An “Info” key 293 can be pressed by a user to access additional information on a particular topic.

It will of course be appreciated that the function(s) associated with the various keys and buttons of the remote controls described above may vary depending on the state of television 100 (e.g., watching television, moving through menus, making menu selections, etc.). Moreover, the layout of the keys and buttons shown in FIG. 2 is not intended to be limiting in any way and various designs for laying out these keys and buttons may be adopted.

Most televisions include one more mechanisms that provide parental controls by which parents can block certain programs from being viewed by children. One such mechanism is the so-called V-chip which allows parents to block programs in accordance with ratings assigned to the programs. These ratings generally include MPAA ratings (e.g., G, PG, PG-13, etc.) which are used to rate movies and the TV Parental Guidelines ratings (e.g., TV-Y, TV-7, TV-G, TV-PG, etc.) used to rate television programs. Some of these TV Parental Guidelines ratings may be accompanied by certain indicators indicating that the program contains violence (V indicator), sexual situations (S indicator), language (L indicator), or suggestive dialogue (D indicator). Generally speaking, televisions include a user interface that allows parents to select which programming is blocked based on the rating of the program.

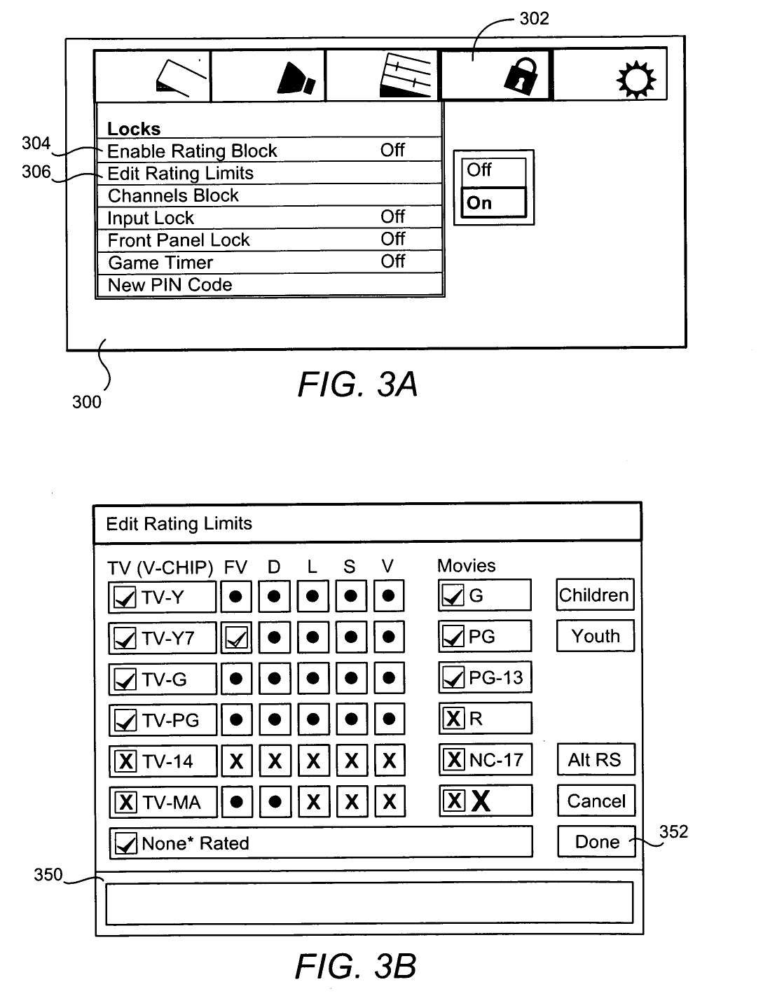

By way of example and without limitation, FIGS. 3A and 3B show an interface that may be used to block programs according to selected ratings. FIG. 3A shows a user interface screen 300. After selecting the lock icon 302 from this screen, the user is prompted to enter a PIN number. If the proper PIN is entered, the user can use navigation keys on remote control 150 (e.g., up and down keys) to highlight menu items on the screen. Highlighting the “Enable Rating Block” menu item 304 allows the user to turn program blocking on or off. Highlighting the “Edit Rating Limits” menu item 306 allows the user to access a rating limit editing screen 350 shown in FIG. 3B. Using the navigation keys on the remote control and then pressing an enter key allows the user to select a preferred level of blocking. In the FIG. 3B example, a box with an “X” is a rating that will be blocked. When the user is done editing the rating limits, the user may highlight “Done” key 352 and press the enter key on the remote control.

If rating blocking is enabled, the television then compares the rating of a TV program or movie (which is sent with the program or movie) with the levels set using the FIG. 3B screen. Blocking/unblocking of the program is based on this comparison. If the program is blocked because of the program's rating, the television may display a screen so informing the user.

As suggested by the FIG. 3A screen, other types of blocking may also be provided. For example, a user can set the television to block certain channels from being tuned for viewing.

In certain instances, it is desirable to temporarily disabling blocking of programs without disabling the rating blocking feature via the interface of FIGS. 3A and 3B. In these instances, blocking on all channels may be temporarily disabled (e.g., until the television is turned OFF and then back ON again) by pressing a specified key (e.g., the MUTE key or some dedicated key) on remote control 150 and then entering an appropriate PIN. This technique is not particularly safe because programs on all channels are not subject to blocking and thus inappropriate programs might then be accessible to children (at least on a temporary basis).

In accordance with the systems and methods described herein, the user is given the option to temporarily disable blocking only a channel (or channels) that it is desired to view; all other channels remain subject to blocking if the programs on those channels exceed the currently set rating levels. In accordance with these systems and methods, parents can, for example, permit children to watch a show that may normally be blocked because its rating exceeds the currently set rating levels, without allowing the children access to programs on other channels that may have ratings which exceed the currently set rating levels.

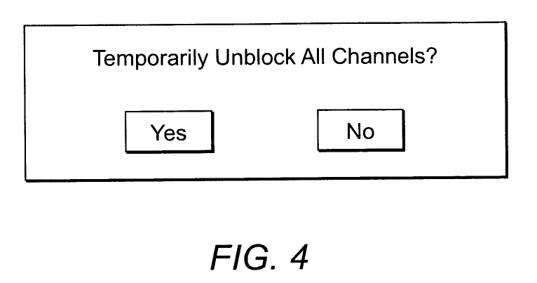

In one non-limiting example system and method, a display such as that shown in FIG. 4 may be added to the graphical user interface. This display is presented after the user presses the specified key for temporary unblocking (e.g., the MUTE key or some dedicated key) and enters the correct PIN to unblock channels. This display provides the user the option of temporarily disabling blocking on all channels or just the currently tuned channel by pressing icon 402 or 404, respectively. The display shown in FIG. 4 may be overlaid onto the display for the currently tuned channel. If the currently-tuned channel is blocked, the display for the channel may, for example, be a screen providing a message to a user regarding the blocking. If the currently-tuned channel is viewable, the display for the channel would be the program currently showing on that channel.

More specifically, assume that the user has enabled rating blocking using the interface screens of FIGS. 3A and 3B. If the user then tunes to a channel having a program with a rating that causes it to be blocked, the user can press the specified key to input a command for temporarily disabling blocking and enter a PIN code. If the PIN code is verified as being correct (e.g., by comparing the entered PIN code to a previously stored code resident in the memory of the television), a display like that in FIG. 4 may be presented which asks the user whether to temporarily disable blocking on all channels. If the user selects YES, then blocking on all channels is temporarily disabled and programs may be viewed on all channels regardless of the rating of the program on the channels. If the user selects NO, then blocking is disabled only the channel the user is on. Thus, if the user were to tune to a channel with a program whose rating exceeds the rating level set for viewing, that program would be blocked.

The temporary disabling of blocking of a single channel is better than temporarily disabling blocking of all channels. For example, suppose a user and his/her family want to watch a program or movie on a specific channel that would ordinarily be blocked because of its rating. If blocking of all channels were temporarily disabled to permit viewing of this program or movie and if the children were left unattended, they would have access to other (now) unblocked programs on other channels that might be unsuitable for their viewing. By disabling blocking on only the channel to which the user is tuned, all other channels can still be subject to blocking. In one example implementation, the temporary disabling of blocking of a channel may end when a new channel is tuned (i.e., the channel is changed).

In another example implementation, when the channel is changed from a (first) channel on which blocking is temporarily disabled and a PIN is entered to temporarily disable blocking on the changed-to (second) channel, the disabling of blocking on the first channel ends.

Other implementations are possible.

By way of example, the temporary disabling of blocking may last until the television is turned OFF. Thus, when the television is turned on again, the channel on which blocking had previously been disabled is once again subject to blocking if the program rating exceeds an allowable rating for viewing.

By way of further example, the temporary disabling of blocking may end when the current program on the channel ends.

By way of still further example, the temporary disabling of blocking may be set to expire based on a user-specified or predetermined time period (e.g., one hours, two hours, etc.). In this case, the computer program code may include instructions for monitoring a timer and for re-enabling blocking when the timer determines that the specified time period is over.

The display of FIG. 4 may be modified to provide for the user to choose when the temporary unblocking should end.

Moreover, although the FIG. 4 display provides options for temporarily unblocking all channels or a currently-tuned-to channel in response to pressing a key on remote control 150, other implementations are possible.

For example, one key on remote control 150 may be used to temporarily disable blocking on all channels (e.g., mute) and another key (e.g., delimiter) may be used to temporarily disable blocking on the currently-tuned-to channel. In response to these keypresses, screens for entering a password and confirming the blocking may be generated.

In another example, the display of FIG. 4 may be modified to provide the capability of temporarily disabling program blocking on multiple channels by, for example, presenting a channel list from which the user may choose. In this case, identifiers for the channels selected from the channel list may be written to memory 120 and the control program may access the list when a channel is tuned to determine whether program blocking on that channel has been temporarily disabled.

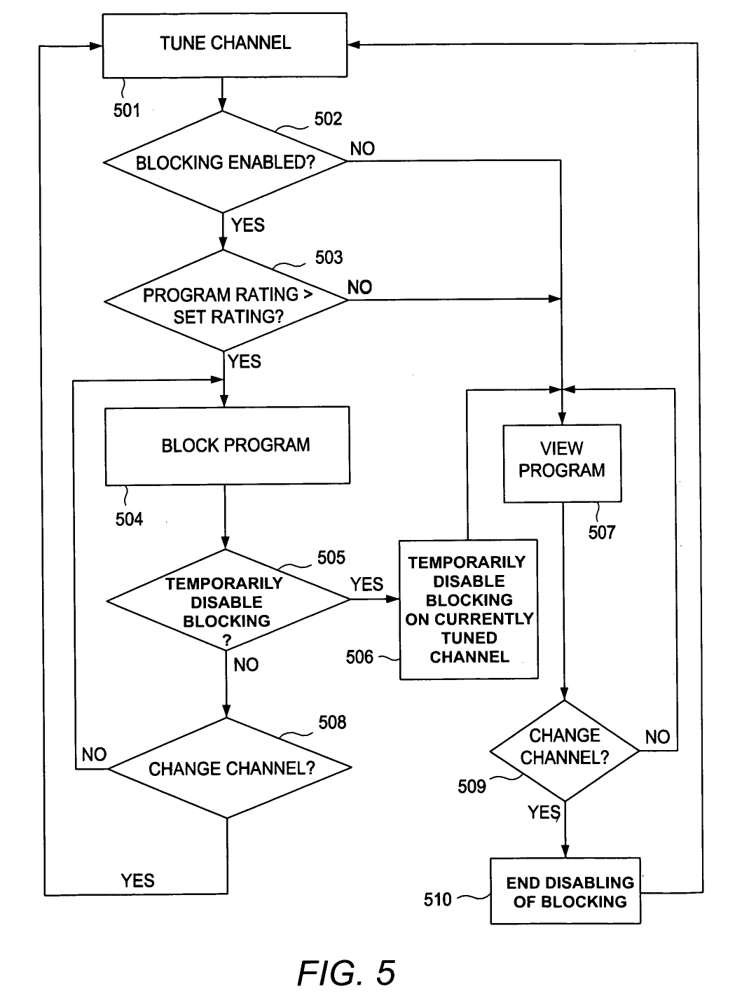

FIG. 5 show steps in a non-limiting example method for implementing the temporary disabling of blocking on a channel in which changing the channel ends the temporary disabling. The steps shown in FIG. 5 may, for example, be implemented by program instructions stored on a tangible computer-readable medium (e.g., memory 120) and executed by control section 114.

At step 501, a channel is tuned. This tuning may be the result of a channel change operation while a user is watching television or the result of tuning the last-viewed channel when the television is turned on. At step 502, a determination is made as to whether blocking is enabled. If not, the program on the currently tuned channel is viewed at step 506. If blocking is enabled, a determination is made at step 503 whether the rating of the program on the currently tuned channel exceeds the allowable rating for viewing set using the screens of FIGS. 3A and 3B. If not, the program on the currently tuned channel is viewed at step 507. If so, the program is blocked at step 504.

If a program is blocked at step 504, a determination is made at step 505 as to whether a temporary blocking disable operation is invoked, for example, by the user pressing a specified key on remote control 150 to supply a temporary blocking disable command. If so, blocking on the currently tuned channel is temporarily disabled at step 506 and the program on the currently tuned channel is viewed at step 507. If not, a determination is made at step 508 as to whether the currently tuned channel is changed. If the channel is not changed, the process returns to step 504 and viewing of the program on the currently tuned channel remains blocked. If the channel is changed at step 508, the process returns to step 501.

If a program is viewed at step 507, a determination is made at step 509 as to whether the currently tuned channel is changed. If not, the process returns to step 507 and the program on the currently tuned channel remains viewable. If the channel is changed, the temporary disabling of blocking of the currently-tuned channel is stopped at step 510 and the process then returns to step 501.

It will be readily apparent that the process shown in FIG. 5 may be readily adapted to provide various implementations such as those described above (e.g., ending temporary disabling of blocking of one channel when blocking on an another channel is temporarily disabled, ending temporary disabling of blocking when the television is turned off, ending temporary disabling of blocking when the current program ends, ending temporary disabling of blocking after a user-specified or predetermined period of time, etc.).

If the FIG. 5 process is modified to permit temporary disabling of blocking on multiple channels, identifiers for each of these channels may be stored in memory 120. While such an implementation is possible and is contemplated within the scope of the systems and methods described herein, the temporary disabling of blocking on multiple channels increases the difficulty of tracking and managing those channels on which blocking is disabled at a particular time. This difficulty may be eased by enabling the user to view a listing of such channels (e.g., by channel number, icon, name, etc.) based, for example, on the identifiers stored in memory 120. This list may be adapted to permit the user to make selections therefrom to, for example, end the temporary disabling of blocking of one or more selected channels.

While the above systems and methods are described with respect to temporarily disabling the blocking of channels subject to rating level blocking, a similar approach may be used with other types of blocking schemes. For example, if the user were to block viewing of certain channels regardless of the rating of the current program, a system and method similar to that described above may be used to provide for temporarily disabling this channel blocking.

As described above, the various aspects of the systems and methods described herein may be implemented as part of an operating program executed by control section 114. This program can, for example, be tangibly embodied on a computer-readable medium such as memory 120. Memory 120 may include magnetic memory, optical memory, semiconductor memory, magneto-optic memory, combinations thereof and the like. In another example, the program may be available for downloading over the internet so that the program may be delivered to television 100 via a communication network. Updates may be provided via downloads to television 100. Further, a carrier wave may be modulated by a signal representing the corresponding program and an obtained modulated wave may be transmitted, so that the television that receives the modulated wave may demodulate the modulated wave to restore the corresponding program.

While the discussion above has been with reference to example embodiments, variations of the example embodiments will be readily apparent and this application is intended to cover various modifications and equivalent arrangements.

I claim:

1. A television comprising:
a memory storing program blocking settings; and
a control system responsive to the stored blocking settings for enabling and disabling program blocking,
wherein the control system selectively blocks programs when program blocking is enabled, and
wherein the control system temporarily disables blocking on a particular channel in response to receiving an unblock command for unblocking that channel.

2. The television according to claim 1, wherein the blocking is disabled for a set time period.

3. The television according to claim 1, wherein the blocking is disabled for a duration of a program.

4. The television according to claim 1, wherein the blocking is disabled until the television is powered off.

5. The television according to claim 1, wherein the control system selectively blocks programs based on a comparison of a program rating transmitted with a program and a rating level set in the blocking settings.

6. The television according to claim 1, wherein the unblock command is supplied via an input to a remote control.

7. The television according to claim 1, wherein the unblock command is supplied in response to a menu selection from a display screen.

8. A program blocking method comprising:
enabling and disabling program blocking on a group of channels responsive to stored blocking settings; and
when program blocking on the group of channels is enabled in response to the stored blocking settings, temporarily disabling the blocking of programs on one or more channels in the group in response to an unblock command for unblocking those channels.

9. The method according to claim 8, wherein the blocking is disabled for a set time period.

10. The method according to claim 8, wherein the blocking is disabled for a duration of a program.

11. The method according to claim 8, wherein the blocking is disabled until the television is powered off.

12. A computer readable medium storing instructions executable by a processor for implementing a program blocking method, the method comprising:
enabling and disabling program blocking on a group of channels responsive to stored blocking settings; and
when program blocking on the group of channels is enabled in response to the stored blocking settings, temporarily disabling the blocking of programs on one or more channels in the group in response to an unblock command for unblocking those channels.

13. The computer readable medium according to claim 12, wherein the blocking is disabled for a set time period.

14. The computer readable medium according to claim 12, wherein the blocking is disabled for a duration of a program.

15. The computer readable medium according to claim 12, wherein the blocking is disabled until the television is powered off.
